(19) United States
(12) Patent Application Publication
(10) Pub. No.: US 2017/0344528 A1
(43) Pub. Date: Nov. 30, 2017

(54) INFORMATION PROCESSING DEVICE AND INPUT CHARACTER CONVERSION METHOD

(71) Applicant: LENOVO (SINGAPORE) PTE. LTD., SINGAPORE (SG)

(72) Inventors: Yasumichi Tsukamoto, Yamato-shi (JP); Yuichi Shigematsu, Sagamihara-shi (JP)

(73) Assignee: LENOVO (SINGAPORE) PTE. LTD., Singapore (SG)

(21) Appl. No.: 15/254,579

(22) Filed: Sep. 1, 2016

(30) Foreign Application Priority Data
May 27, 2016 (JP) 2016-106394

(51) Int. Cl. G06F 17/24; G06F 17/27; G06F 3/0484

(52) U.S. Cl. CPC G06F 17/24; G06F 3/04842; G06F 17/276

(57) ABSTRACT

The present invention performs inputting of characters for which numerical value calculations and so forth are requested in advance. When an event character string has been input by an input unit and it has been decided that a specific character is included in the character string, a laptop PC extracts the character string that includes the specific character as a conversion object character string and derives a conversion candidate for the conversion object character string according to the specific character. Then, the laptop PC makes the conversion candidate display on a touch-panel display and converts the conversion object character string into the conversion candidate that has been selected by a user.

### FIELD OF THE INVENTION

The present invention relates to an information processing device and an input character conversion method.

### BACKGROUND OF THE INVENTION

When a user prepares a document or a sentence by using document or sentence preparation software (hereinafter, referred to as word-processing software), there are cases where inputting of a result of calculations executed and so forth is performed in the form of a numerical formula.

In such a case, the user separately activates another piece of arithmetic operation software such as, for example, desktop calculator software and so forth, performs a numerical value calculations by using the arithmetic operation software and inputs a result of the calculation so performed into the word processing software.

### SUMMARY OF THE INVENTION

### Problems to be Solved by the Invention

However, work of activating another piece of arithmetic operation software and performing the numerical value calculations while preparing the document or the sentence by using the word processing software is a troublesome operation for the user.

The present invention has been made in view of the above mentioned disadvantage and aims to provide an information processing device and an input character conversion method allowing easy inputting of characters for which numerical value calculations and so forth are requested in advance.

### Means for Solving the Problems

In order to solve the above-mentioned disadvantage, the information processing device and the input character conversion method adopt the following configurations.

According to a first aspect of the present invention, there is provided an information processing device that includes an image display unit that displays an image, and an input unit that accepts inputting of characters, and further includes an event decision unit that decides that a predetermined event has been input at least before or after a character string that has been input by the input unit, a specific character decision unit that decides that a specific character that has been determined in advance is included in the character string when it has been decided that the predetermined event has been input by the event decision unit, a conversion candidate derivation unit that extracts the character string that includes the specific character as a conversion object character string and derives a conversion candidate for the conversion object character string according to the specific character when it has been decided that the specific character is included by the specific character decision unit, a conversion candidate display control unit that makes the conversion candidate that has been derived by the conversion candidate derivation unit display on the image display unit, and a character conversion control unit that converts the conversion object character string into the conversion candidate that has been selected by a user.

According to a second aspect of the present invention, there is provided an input character conversion method for an information processing device that includes an image display unit that displays an image and an input unit that accepts inputting of a character, and the method includes deciding that a predetermined event has been input at least before or after a character string that has been input by the input unit, deciding that a specific character that has been determined in advance is included in the character string when it has been decided that the predetermined event has been input, extracting the character string that includes the specific character as a conversion object character string and deriving a conversion candidate for the conversion object character string according to the specific character when it has been decided that the specific character is included, displaying the conversion candidate that has been derived on the image display unit, and converting the conversion object character string into the conversion candidate that has been selected by a user.

According to a third aspect of the present invention, there is provided a program that makes a computer that an information processing device that includes an image display unit that displays an image and an input unit that accepts inputting of a character has function as an event decision unit that decides that a predetermined event has been input at least before or after a character string that has been input by the input unit, a specific character decision unit that decides that a specific character that has been determined in advance is included in the character string when it has been decided that the predetermined event has been input by the event decision unit, a conversion candidate derivation unit that extracts the character string that includes the specific character as a conversion object character string and derives a conversion candidate for the conversion object character string according to the specific character when it has been decided that the specific character is included by the specific character decision unit, a conversion candidate display control unit that makes the conversion candidate that has been derived by the conversion candidate derivation unit display on the image display unit, and a character conversion control unit that converts the conversion object character string into the conversion candidate that has been selected by a user.

### Effects of the Invention

According to the present invention, such an advantageous effect that it is possible to easily perform inputting of the characters for which it is requested to perform the numerical value calculations and so forth in advance is obtained.

### BRIEF DESCRIPTION OF THE DRAWINGS

FIG. is a schematic outside view illustrating one example of a laptop PC according to one embodiment of the present invention.

FIG. 2 is a block diagram illustrating one example of an electrical configuration of the laptop PC according to one embodiment of the present invention.

FIG. 3A is a diagram illustrating one example of an input character conversion function according to one embodiment of the present invention.

FIG. 3B is a diagram illustrating one example of the input character conversion function according to one embodiment of the present invention.

FIG. 3C is a diagram illustrating one example of the input character conversion function according to one embodiment of the present invention.

FIG. 4 is a functional block diagram illustrating one example of a configuration relevant to the input character conversion function according to one embodiment of the present invention.

FIG. 5 is a flowchart illustrating one example of a flow of processing relevant to the input character conversion function according to one embodiment of the present invention.

### DETAILED DESCRIPTION OF THE INVENTION

In the following, embodiments of an information processing device and an input character conversion method according to the present invention will be described with reference to the appended drawings.

FIG. 1 is a schematic outside view illustrating one example of a laptop PC 1 according to one embodiment.

As illustrated in FIG. 1, the laptop PC 1 includes, for example, a main body side chassis 2 and a display side chassis 3 that are almost rectangular in shape.

The main body side chassis 2 includes an input unit 4. The input unit 4 is a user interface through which a user performs an inputting operation, and includes a keyboard configured by various kinds of keys that accept inputting of characters, commands and so forth, and a touch pad, a mouse, a track point and so forth used to move a cursor on a screen and to select various kinds of menus. In addition, the input unit 4 may be configured as a software keyboard.

The display side chassis 3 includes a touch panel display 7 that displays an image.

The touch panel display 7 converts display data that is input into a video signal and displays various kinds of information according to the converted video signal on a display screen, and detects various kinds of operations that are performed by using fingers of the user and indicators such as a touch pen and so forth.

The main body side chassis 2 and the display side chassis 3 are coupled together by one pair of right and left coupling parts 8b and 8a at ends of the respective chassis. The coupling parts 8a and 8b are hinges and support the main body side chassis 2 and the display side chassis 3 so as to be openable and closeable.

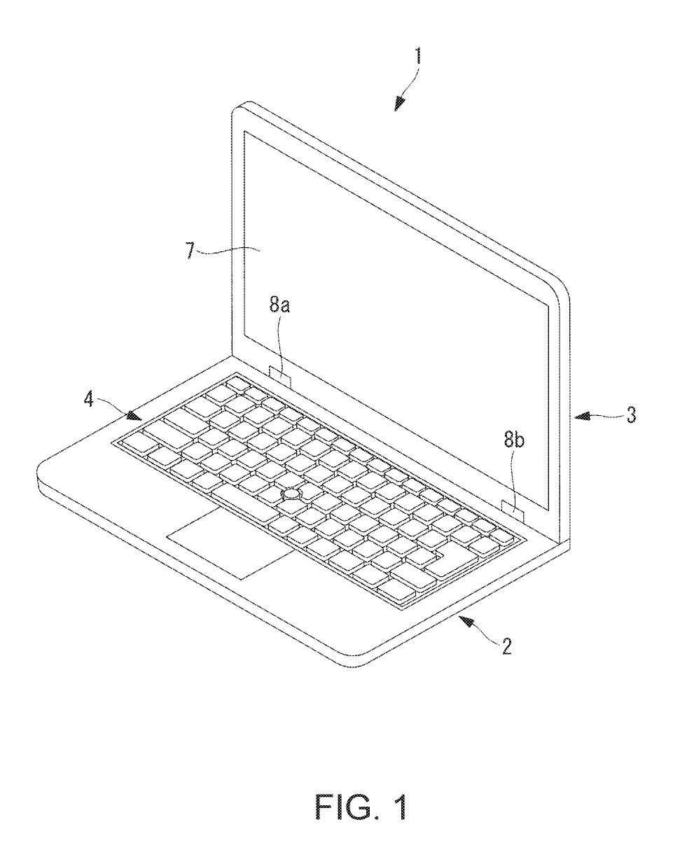

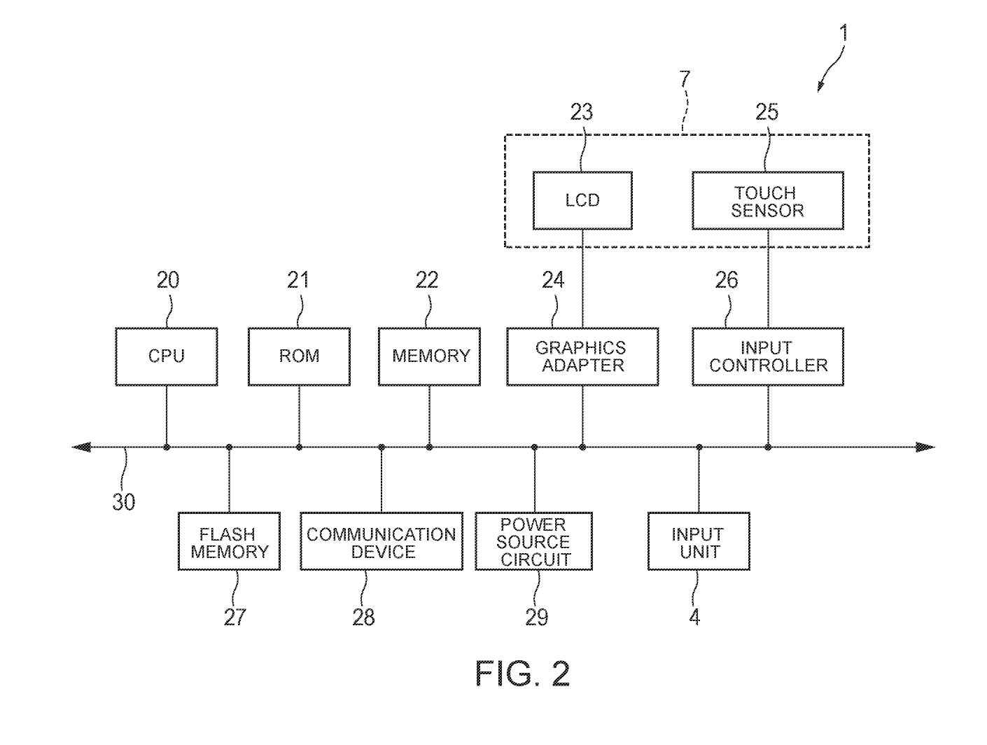

FIG. 2 is a schematic diagram illustrating one example of a configuration of hardware of the laptop PC 1.

The laptop PC 1 includes a CPU (Central processing Unit) 20, a ROM (Read Only Memory) 21, a memory 22, an LCD (Liquid Crystal Display) 23, a graphics adapter 24, a touch sensor 25, an input controller 26, a flash memory 27, a communication device 28, a power source circuit 29 and so forth. The respective units are connected together directly or indirectly via a bus 30. Incidentally, the touch panel display 7 includes the LCD 23 and the touch sensor 25.

The CPU 20 performs control of the entire laptop PC 1 in accordance with an OS (Operating System) stored in the flash memory 27 and has a function of executing processing according to an operation of the user that is performed via the input unit 4, the touch panel display 7 and so forth on the basis of various kinds of programs stored in the flash memory 27.

The ROM 21 stores therein BIOS (Basic Input/Output System), various kinds of data and so forth.

The memory 22 is a writable memory that includes a cache memory, a RAM (Random Access Memory) and so forth and is utilized as a workspace that performs reading of an execution program of the CPU 20 and writing of processing data according to the execution program.

The LCD 23 displays the video signal sent from the graphics adapter 24 as the image in accordance with control by the CPU 20.

The graphics adapter (Graphics Processing Unit: also called “GPU”) 24 converts display information into the video signal and outputs the converted video signal to the LCD 23 in accordance with the control by the CPU 20.

The touch sensor 25 detects a touch position of the finger of the user, the touch pen and so forth on the LCD 23 and outputs the touch position so detected to the input controller 26. Then, the touch sensor 25 allows the user to perform the inputting operation by selecting one of screen objects such as various kinds of menus, icons and buttons, a keyboard and so forth that are displayed on the screen of the LCD 23, to perform a text inputting operation and to perform screen manipulations such as scrolling, swiping and so forth by using the finger of the user, the touch pen and so forth.

The input controller 26 performs various processes by executing a program stored in the ROM 21 and so forth by using a processor and controls the operation of the touch sensor 25.

The flash memory 27 has a function of storing the OS used to control the entire laptop PC 1, various kinds of drivers for operating peripherals and so forth by hardware, applications oriented to specific tasks, various kinds of data, various kinds of files and so forth. Incidentally, the laptop PC 1 may include other storage elements such as an HDD (Hard Disk Drive) and so forth as the storage elements that are used in place of the flash memory 27.

The communication device 28 performs communication with other devices.

The power source circuit 29 includes an AC adapter, an intelligent battery, a battery charger that charges the intelligent battery, a DC/DC converter and so forth and supplies power to each device in accordance with the control by the CPU 20.

The laptop PC 1 according to the present embodiment has a character conversion function of performing, when a character string has been input into the word-processing software, an arithmetic operation in line on the basis of the character string so input and thereby converting an input character into a result of the arithmetic operation so performed. Here, the character string also includes a case of one character, not limited to a case of the plurality of characters. In addition, the characters include numerals, symbols and so forth, in addition to alphabets and so forth.

The input character conversion function is adapted to decide whether a specific character that has been determined in advance is included in the character string when a predetermined event has been input at least before or after the character string that has been input by the input unit 4. The character string is extracted as a conversion object character string when the specific character is included in the character string. Then, the input character conversion function is also adapted to display a conversion candidate for the conversion object character string according to the specific character.

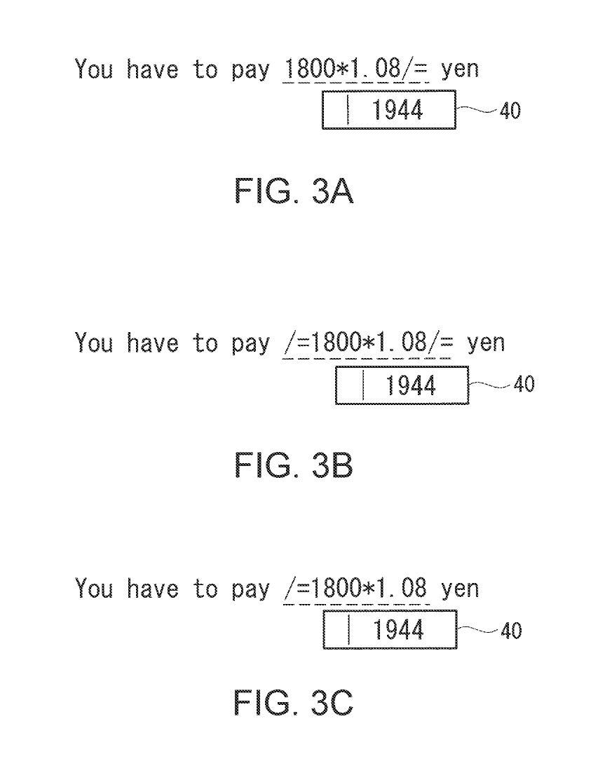

FIG. 3A, FIG. 3B and FIG. 3C each is a diagram illustrating one example of the input character conversion function.

The above-mentioned predetermined event, for example, inputting of the character string that has been determined in advance (hereinafter, referred to as an “event character string”) and key-in that has been determined in advance (hereinafter, referred to as “event key-in”).

In each of FIG. 3A, FIG. 3B and FIG. 3C, the input character string that includes the event character string is illustrated. One example of the event character string is “/=” that two characters have been combined with each other. Other character strings such as, for example, “#=”, “:=” and so forth may be used not limited to “/=”. FIG. 3A illustrates one example that the event character string has been input after the input character string “1800*1.08”. FIG. 3B illustrates one example that the event character string has been input before and after the input character string. FIG. 3C illustrates one example that the event character string has been input before the input character string.

On the other hand, when the predetermined event is the event key-in, the event key-in is performed in place of inputting of the event character string at a position where the event character string has been input such as that illustrated in each of FIG. 3A to FIG. 3C. The event key-in is inputting into a key that has been set in advance such as, for example, a function key “F1” and so forth and the event key-in may be performed by simultaneously pressing the plurality of keys. In addition, when the input unit 4 is a software keyboard, an event key that is different from an existing key may be separately installed.

In the examples in FIG. 3A to FIG. 3C, the specific character is “*”. This specific character is a mathematical symbol and means a multiplication. Other mathematical symbols to be set as the specific characters may be other mathematical symbols such as a “+” that means an addition, a “−” that means a subtraction, a “÷” that means a division and so forth.

When the event character string has been input after the input character string as illustrated in FIG. 3A, whether the specific character is included in the characters of a predetermined number (for example, twenty characters) located before the event character string is decided by using the input character conversion function. When the event character strings have been input before and after the input character string as illustrated in FIG. 3B, whether the specific character is included in the input character string that has been interposed between the event character strings is decided by using the input character conversion function. When the event character string has been input before the input character string as illustrated in FIG. 3C, whether the specific character string is included in the characters of the predetermined number (for example, twenty characters) located after the event character string is decided by using the input character conversion function.

Incidentally, in the following description, one example that the event character string is input after the input character string as the predetermined event will be described.

The conversion candidate for the conversion object character string according to the specific character is displayed by using the input character conversion function. The conversion object character string indicated in the example in FIG. 3A is “1800*1.08/=” that includes the event character string “/=” and is configured by “1800” and “1.08” that are numerals located before and after the specific character. Then, the conversion candidate is “1944” that is a result of the arithmetic operation performed by multiplying “1800” by “1.08”. The conversion candidate is displayed on a conversion candidate display window 40.

When the user selects the conversion candidate that is displayed on the conversion candidate display window 40, “1800*1.08/=” is converted into “1944” and display is made on the touch panel display 7, for example, in the form of “You have to pay 1944 yen” by using the input character conversion function. As indicated in this example, the event character string is not displayed on the touch panel display 7 after conversion has been performed.

As described above, in the input character conversion function according to the present embodiment, when the event character string has been input, the arithmetic operation and so forth is performed on the input character string located before and/or after the event character string in line and thereby character string conversion is performed.

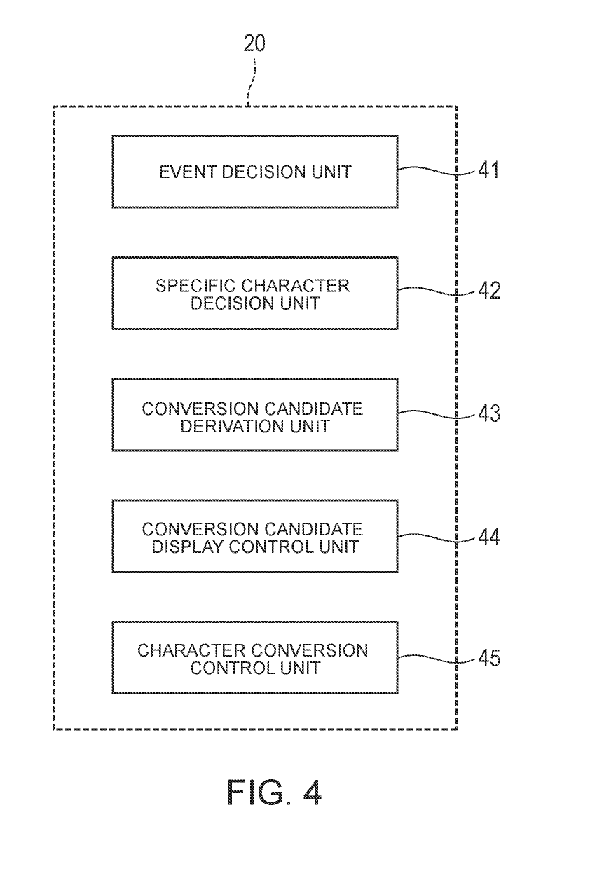

FIG. 4 is a functional block diagram illustrating one example of a configuration relevant to the input character conversion function.

The CPU 20 includes an event decision unit 41, a specific character decision unit 42, a conversion candidate derivation unit 43, a conversion candidate display control unit 44, a character conversion control unit 45 and so forth. Incidentally, the functions of these units are implemented by software.

The event decision unit 41 decides that the event character string has been input at least before or after the character string that has been input by the input unit 4.

When it has been decided that the event character string has been input by the event decision unit 41, the specific character decision unit 42 decides (analyzes) that the specific character that has been determined in advance is included in the input character string.

When it has been decided that the specific character is included in the input character string by the specific character decision unit 42, the conversion candidate derivation unit 43 extracts the input character string that includes the specific character as the conversion object character string and derives the conversion candidate for the conversion object character string according to the specific character.

Here, derivation of the conversion candidate will be specifically described by giving one example.

As one example, the conversion candidate derivation unit 43 performs the arithmetic operation that is based on the input specific character and derives a result of the arithmetic operation so performed as the conversion candidate.

For example, as illustrated in FIG. 3A to FIG. 3C, when the specific character that has been input is the mathematical symbol, the conversion candidate derivation unit 43 derives the solution according to the mathematical symbol as the conversion candidate.

In addition, when the specific character that has been input is the character relevant to the date, the conversion candidate derivation unit 43 derives another inscription according to the date as the conversion candidate. The specific character relevant to the date is “/” as indicated in the following example and, as another inscription, an English inscription that includes an abbreviated inscription of a month is derived as the conversion candidate. That is, in the following example, the conversion object character string is “1972/12/15/=” and the conversion candidate is “Dec 15^{th}, 1972”.

I was born in 1972/12/15/=→I was born in Dec 15^{th}, 1972

Incidentally, when the specific character is “/”, it may possibly be decided that “/” is the character or the mathematical symbol relevant to the date. In such a case, the plurality of conversion candidates such as the conversion candidate obtained when “/” has been decided as the character relevant to the date, the conversion candidate obtained when “/” has been decided as the mathematical symbol and so forth may be displayed. In addition, numerals that are larger than 13 are not included in the numerals that indicate the months and numerals that is larger than 32 are not included in the numerals that indicate the days of the month. Accordingly, the conversion candidate derivation unit 43 may decide whether “/” is the character relevant to the date on the basis of the arrayed order of the numerals and/or the magnitude of the numerals included in the conversion object character string.

When the specific character that has been input is the character relevant to the day of the week, the conversion candidate derivation unit 43 derives month and day according to the day of the week as the conversion candidate. The specific character relevant to the day of the week is the day itself of the week or the day of the week that has been written together with “next” or “last” as indicated in the following example, and as another inscription, the month and day is derived as the conversion candidate. That is, in the following example, the conversion object character string is “next Friday/=” and the conversion candidate is “July 10^{th}”.

Please finish by next Friday/=→Please finish by July 10^{th}

When the specific character that has been input is a character relevant to a time, the conversion candidate derivation unit 43 derives another inscription according to the time as the conversion candidate. The specific character relevant to the time is “PST” that is the abbreviated word of Pacific Standard Time as indicated in the following example and, as another inscription, the time of a nation that the user has set in advance is derived as the conversion candidate. That is, in the following example, the conversion object character string is “10:00PST/=” and the conversion candidate is “20:00 your time”. Incidentally, when there exists the plurality of nations that the user has set in advance, the plurality of times corresponding to the respective nations is displayed as the conversion candidates.

Please call me at 10:00PST/=→Please call me at 20:00 your time

When the specific character that has been input is a currency, the conversion candidate derivation unit 43 derives a converted value into another currency as the conversion candidate. The specific character that indicates the currency is “yen” that indicates the currency of Japan as indicated in the following example and, as another currency, the converted value into the currency of the nation that the user has set in advance is derived as the conversion candidate. That is, in the following example, the conversion object character string is “20Kyen” and the conversion candidate is “20Kyen (162USD). Incidentally, when there exists the plurality of currencies that has been set and converted, the plurality of converted values corresponding to the respective currencies is displayed as the conversion candidates. In addition, as the specific character that indicates the currency, the currencies of the plurality of nations such as “USD” that indicates the US dollar and so forth may be set in advance in addition to “yen” that means the Japanese yen. A conversion factor used for calculation of the converted value may be set in advance and a current value of the conversion factor may be acquired in real time over a network.

This sample cost is 20Kyen/=→This sample cost is 20Kyen (162USD)

Further, the memory 22 that is a storage unit may store the conversion candidate according to the specific character and the conversion candidate derivation unit 43 may read the conversion candidate according to the specific character that has been input out of the storage unit.

When the specific character that has been input is an abbreviated word, the conversion candidate derivation unit 43 reads a term that corresponds to the abbreviated word out of the memory 22 and derives the term so read-out as the conversion candidate. For example, terms (not abbreviated terms, that is, formal names) corresponding to abbreviation words of business terms are derived as the conversion candidates as indicated in the following example. That is, in the following example, the conversion object character strings are “IMO/=” and “NRN/=” and the conversion candidates are “in my opinion” and “No replay necessary”.

IMO/=→in my opinion

NRN/=→No replay necessary

The conversion candidate display control unit 44 makes the conversion candidate that has been derived by the conversion candidate derivation unit 43 display on the touch panel display 7. More specifically, the conversion candidate is displayed on the conversion candidate display window 40. When there exists the plurality of conversion candidates, the plurality of conversion candidates is displayed on the conversion candidate display window 40. The user selects one of the conversion candidates displayed on the conversion candidate display window 40.

The character conversion control unit 45 converts the conversion object character string into the conversion candidate that has been selected by the user.

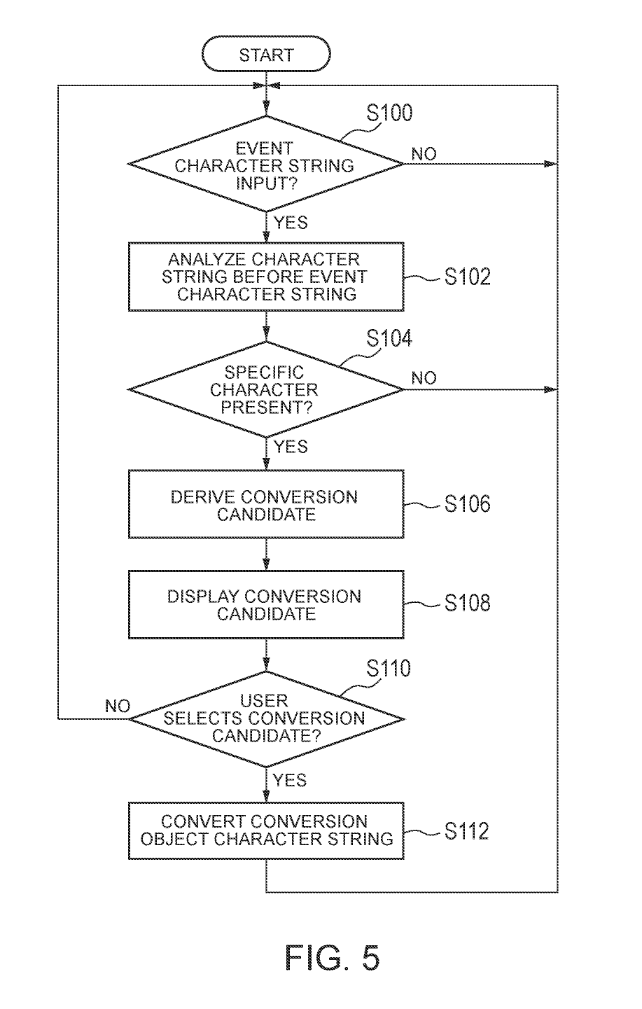

FIG. 5 is a flowchart illustrating one example of a flow of processing relevant to the input character conversion function. As described above, when the word-processing software is activated and the user performs character inputting, the input character conversion function functions in the background thereof.

First, in step 100, whether the event character such as “/=” and so forth has been input into the character string that has been input is decided, and in case of a positive decision, the process shifts to step 102.

In step 102, whether the specific character is included in the character string located before the event character string that has been input is analyzed.

In the next step 104, whether the specific character is included is decided, and in case of the positive decision, the process shifts to step 106. On the other hand, in case of a negative decision, the process returns to step 100.

In step 106, the character string that includes the specific character is extracted as the conversion object character string, and the conversion candidate for the conversion object character string according to the specific character is derived.

In the next step 108, the conversion candidate so derived is displayed on the conversion candidate display window 40.

In the next step 110, whether the user has selected the conversion candidate is decided, and in case of the positive decision, the process shifts to step 112. Incidentally, when the user moves the cursor to the conversion candidate that is being displayed on the conversion candidate display window 40 and the Enter key has been pressed, it is decided that the user has selected the conversion candidate.

In step 112, the conversion object character string is converted into the conversion candidate that has been selected by the user and is displayed on the touch panel display 7, and the process returns to step 100.

On the other hand, in step 110, when the user has performed inputting of a new character with no selection of the conversion candidate, the conversion object character string is not converted, display on the conversion candidate display window 40 disappears and the process returns to step 100.

As described above, when the event character string is input and it has been decided that the specific character is included in the character string, the laptop PC 1 according to the present embodiment extracts the character string that includes the specific character as the conversion object character string and derives the conversion candidate for the conversion object character string according to the specific character. Then, the laptop PC 1 makes the conversion candidate display on the touch panel display 7 and converts the conversion object character string into the conversion candidate that has been selected by the user. Thereby, since it is not requested for the user to separately perform the numerical value calculation and so forth by activating the arithmetic operation software, it is possible to easily perform inputting of the character for which the calculation of the numerical values and so forth is requested in advance.

Although in the foregoing, the present invention has been described by using the above-mentioned embodiments, the technical range of the present invention is not limited to the range described in the above-mentioned embodiment. It is possible to alternate and improve the above-mentioned embodiment in a variety of ways within a range not deviating from the gist of the present invention and embodiments so altered and improved are also included in the technical range of the present invention. In addition, the above-mentioned embodiments may be appropriately combined with one another.

For example, although in the above-mentioned embodiment, the example that the information processing device is configured by the laptop PC 1, the present invention is not limited to the above-mentioned example, and the information processing device may be other information processing devices such as a desktop PC, a tablet PC, a mobile phone, a smartphone and so forth.

In addition, although in the above-mentioned embodiments, the example that when the conversion object character string is to be converted into the conversion candidate, the conversion candidate is displayed on the conversion candidate display window 40 and the user selects the conversion candidate has been described, the present invention is not limited to this example. For example, when the specific character has been input, the conversion object character string may be automatically converted into the conversion candidate without displaying the conversion candidate on the conversion candidate display window 40. Incidentally, when there exists the plurality of conversion candidates, the plurality of conversion candidates is displayed on the conversion candidate display window 40 and the user selects one of them.

We claim:

1. An information processing device comprising:
an image display unit configured to display an image;
an input unit configured to accept input of characters;
an event decision unit configured to decide whether a predetermined event has been input before or after a character string that input by the input unit;
a specific character decision unit configured to decide whether a specific character is included in the character string when the event decision unit has decided that the predetermined event has been input;
a conversion candidate derivation unit configured to extract the character string that includes the specific character as a conversion object character string, and derive a conversion candidate for the conversion object character string according to the specific character when the specific character decision unit has decided that the specific character is included in the character string;
a conversion candidate display control unit configured to make the conversion candidate display on the image display unit; and
a character conversion control unit configured to convert the conversion object character string into the conversion candidate selected by a user.

2. The information processing device according to claim 1, wherein:
the event decision unit functions when the character string has been input into a word-processing software.

3. The information processing device according to claim 1, wherein:
the predetermined event is a character string that has been determined in advance.

4. The information processing device according to claim 3, wherein:
the character string is not displayed on the image display unit after the character conversion control unit has converted the conversion object character string into the conversion candidate.

5. The information processing device according to claim 1, wherein:
the predetermined event is a key-in that has been determined in advance.

6. The information processing device according to claim 1, wherein:
the conversion candidate derivation unit performs an arithmetic operation based on the specific character inputted and derives a result of an arithmetic operation as the conversion candidate.

7. The information processing device according to claim 6, wherein:
when the specific character inputted is a mathematical symbol, the conversion candidate derivation unit derives a solution according to the mathematical symbol as the conversion candidate.

8. The information processing device according to claim 6, wherein:
when the specific character inputted is a character relevant to a date, and the conversion candidate derivation unit derives an inscription according to the date as the conversion candidate.

9. The information processing device according to claim 6, wherein:
when the specific character inputted is a character relevant to a day of the week, the conversion candidate derivation unit derives a month and a day according to the day of the week as the conversion candidate.

10. The information processing device according to claim 6, wherein:
when the specific character inputted is a character relevant to a time, the conversion candidate derivation unit derives another inscription according to the time as the conversion candidate.

11. The information processing device according to claim 6, wherein:
when the specific character inputted is a character relevant to a currency, the conversion candidate derivation unit derives a converted value in another currency as the conversion candidate.

12. The information processing device according to claim 1, further comprising:
a storage unit configured to store the conversion candidate according to the specific character input, wherein:
the conversion candidate derivation unit reads the conversion candidate according to the specific character input stored in the storage unit.

13. The information processing device according to claim 12, wherein:
when the specific character inputted is an abbreviated word, the conversion candidate derivation unit reads a term corresponding to the abbreviated word stored in the storage unit and derives the term as the conversion candidate.

14. An input character conversion method for an information processing device that includes an image display unit for displaying an image and an input unit for accepting input of characters, comprising:
deciding whether a predetermined event has been input before or after a character string has been input by the input unit;
deciding whether a specific character is included in the character string when it has been decided that the predetermined event has been input;
extracting the character string that includes the specific character as a conversion object character string, and deriving a conversion candidate for the conversion object character string according to the specific character when it has been decided that the specific character is included;
displaying the conversion candidate on the image display unit; and
converting the conversion object character string into the conversion candidate selected by a user.

15. A program for making a computer an information processing device that includes an image display unit for displaying an image and an input unit for accepting input of characters comprising:
an event decision unit configured to decide whether a predetermined event has been input before or after a character string that input by the input unit;
a specific character decision unit configured to decide whether a specific character is included in the character string when the event decision unit has decided that the predetermined event has been input;
a conversion candidate derivation unit configured to extract the character string that includes the specific character as a conversion object character string, and derive a conversion candidate for the conversion object character string according to the specific character when the specific character decision unit has decided that the specific character is included;
a conversion candidate display control unit configured to make the conversion candidate display on the image display unit; and
a character conversion control unit configured to convert the conversion object character string into the conversion candidate selected by a user.
